(19) United States
(12) Patent Application Publication
(10) Pub. No.: US 2010/0231937 A1
(43) Pub. Date: Sep. 16, 2010

(54) PRINT APPARATUS AND PRINT SYSTEM AND METHOD OF CONTROLLING THE PRINT APPARATUS

(75) Inventor: Kiyohiro Tsunekawa, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/716,927

(22) Filed: Mar. 3, 2010

(30) Foreign Application Priority Data
Mar. 16, 2009 (JP) 2009-063239

(51) Int. Cl. G06F 15/00

(52) U.S. Cl. 358/1.9; 358/1.15

(57) ABSTRACT

A print job from a first PC is received and stored with a print attribute, and update information to update the print attribute is notified to the first PC. The first PC transmits a mail describing the update information to a second and/or subsequent PCs, and if these second or subsequent PCs access the transmitted update information, then the print attribute stored in a printer is updated, and in correspondence with a print start instruction, printing based on the print data is performed in accordance with the updated print attribute.

### BACKGROUND OF THE INVENTION

1. Field of the Invention

The present invention relates to a print apparatus for printing an image on a print medium in accordance with print data, a print system having an information processing apparatus connected to the print apparatus, and a method of controlling the print apparatus.

2. Description of the Related Art

In many cases, at conferences or meetings in offices and companies, or at various events, recitals, presentations (hereinbelow, briefly noted as a “conference”), materials are prepared which are later delivered as handouts to the respective participants. In this case, as the organizer of the conference or material originator prepares such materials previously, in view of print costs and the like, there is a need to prepare printouts in correspondence with the number of the participants of the conference in just proportion. Such a need is stronger particularly when the number of participants cannot be accurately obtained in advance.

On the other hand, in recent years, by virtue of progress of electrophotographic technology, various materials and printouts can be prepared in offices using a laser-beam printer or a multifunction peripheral. In this case, a printer driver operating on a host computer converts a print instruction from application software operating on the host computer into PDL data interpretable for the multifunction peripheral and transmits the converted data to the multifunction peripheral. The multifunction peripheral interprets the received PDL data, generates a bitmap image (page image) constructing the content of the page, and in accordance with necessity, holds the data as a saved job in a hard disk or the like. Further, the multifunction peripheral that handles such saved job can make an instruction by remote access from a console unit or an external device to change print attribute information of the saved job and perform printing. Note that as an example of the print attribute information, the number of copies (“copies”), print surface designation such as double side/single-side, layout information such as binding margin are included. As a multifunction peripheral configured to handle such saved job, as described in Japanese Patent Application Laid-Open No. 9-114326, an apparatus having a so-called print reservation function for printing a saved job at previously designated time is known.

The above-described Japanese Patent Application Laid-Open No. 9-114326 proposes an image forming apparatus capable of reservation of print time for image data stored in an image memory. At the reserved time, the image data is read out from the image memory and printing is performed based on the read image data.

For a conference where the organizer provides printouts for plural participants, when the number of participants cannot be accurately determined in advance, the problem is that the number of participants and the number of printouts do not correspond with each other. Conventionally, to address such problem, first, the organizer (hereinbelow, referred to as a “first user”) issues a leaflet to prospective participants (hereinbelow, referred to as “second users”). Then, the responses from the second and/or subsequent users who expressed their willingness to participate in the conference is counted, then processing to print materials to be delivered at the conference in the number of the prospective participants is performed. Accordingly, it is necessary for the first user to count the responses from the second and/or subsequent users one by one and determine the number of copies of the materials. Further, in the above-described processing flow, merely a print instruction for printing of the materials is made based on the number of copies determined by the counting by the first user, and any particular thought is not taken for preparation of materials in just proportion in a more simple manner thereby reducing the first user's labor.

On the other hand, the print attribute information (particularly the number of copies) of a saved job including reserved printing can be changed by a user's operation to an arbitrary numerical value, however, to determine the number of copies, counting processing or the like by the first user is required, accordingly, the load on the user cannot be reduced.

### SUMMARY OF THE INVENTION

An aspect of the present invention is to eliminate the above-mentioned problems with the conventional technology.

Another aspect of the present invention is to notify update information to update a print attribute of a print job held in a print apparatus to an information processing apparatus, and automatically update the print attribute in accordance with access from the information processing apparatus to the update information.

According to an aspect of the present invention, there is provided a print apparatus, comprises: a storage unit that stores received print data with a print attribute; a notification unit that notifies an information processing apparatus of update information to update the print attribute; an update unit that updates the print attribute in accordance with an access from the information processing apparatus to the update information; and a print control unit that performs printing based on the print data in accordance with the updated print attribute in correspondence with a print start instruction for the print data.

According to another aspect of the present invention, there is provided a print system in which a print apparatus and a plurality of information processing apparatuses are interconnected via a network, wherein the print apparatus comprises: a storage unit that receives a print job from a first information processing apparatus and stores the received print job with a print attribute; a notification unit that notifies the first information processing apparatus of update information to update the print attribute; an update unit that updates the print attribute in accordance with an access to the update information from the information processing apparatus; and a print control unit that performs printing based on the print data in accordance with the updated print attribute, in response to a print start instruction for the print data, wherein the first information processing apparatus having a transmission unit that transmits the update information to other information processing apparatus than the first information processing apparatus, and wherein the other information processing apparatus than the first information processing apparatus having a unit that accesses the update information transmitted by the transmission unit.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration of a print system according to a first embodiment of the present invention;

FIG. 2 is a block diagram showing a configuration of a PC according to the first embodiment;

FIG. 3 depicts a view illustrating an example of a GUI screen of a printer driver according to the first embodiment;

FIG. 4A depicts a view illustrating an example of a structure of saved job management information according to the first embodiment;

FIG. 4B depicts a view illustrating an example of saved job management information according to the first embodiment;

FIG. 5 depicts a view illustrating an example of an electronic mail of conference leaflet transmitted from a first PC in the first embodiment;

FIG. 6 is a flowchart describing a copies update job registration procedure according to the first embodiment;

FIG. 7 is a flowchart describing a print copies update procedure according to the first embodiment;

FIG. 8A depicts a view illustrating an example of saved job management information according to a second embodiment of the present invention;

FIG. 8B depicts a view illustrating an example of the electronic mail according to the second embodiment;

FIG. 9 depicts a view illustrating an example of the saved job management information according to a third embodiment of the present invention;

FIG. 10 is a flowchart describing the copies update procedure according to a fifth embodiment of the present invention; and

FIG. 11 depicts a view illustrating an example of the saved job management information according to a sixth embodiment of the present invention.

### DESCRIPTION OF THE EMBODIMENTS

Hereinbelow, embodiments of the present invention will now be described in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

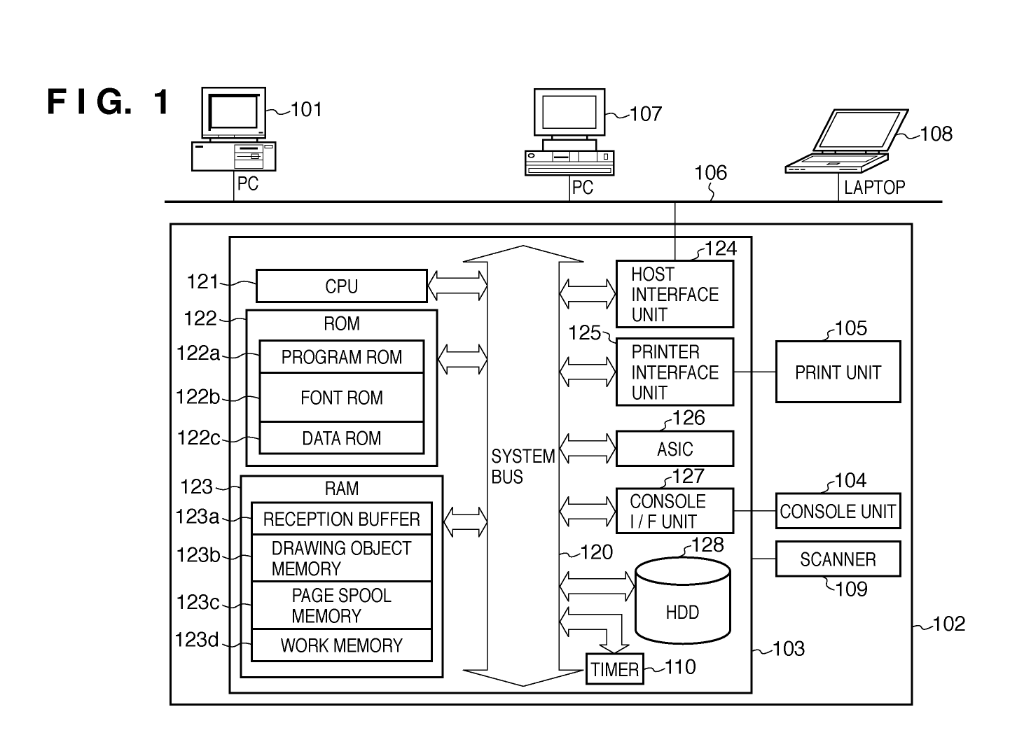

FIG. 1 is a block diagram showing a configuration of a print system including a print apparatus according to a first embodiment of the present invention.

A printer device (hereinbelow, “printer”) 102 has a printer control unit (controller) 103, a console unit 104 and a print unit (print engine) 105. In the controller 103, a CPU 121 controls the respective elements connected to a system bus 120. Further, the CPU 121 generates image data for printing based on a control program stored in a program ROM 122a of a ROM 122, and supplies a video signal corresponding to the image data via a printer interface unit 125 to the print unit (print engine) 105. The program ROM 122a includes at least one type of page description language interpretation program (hereinbelow, a “PDL interpreter”). Further, the CPU 121 interprets a print job supplied from a host computer (PC) 101 and converts the print job to bitmap data printable for the print unit 105 by executing the PDL interpreter loaded to a RAM 123.

Further, in some cases, in the printer 102, an optional ROM is provided attachably to an extended ROM slot (not shown), and other types of PDL interpreters included in the operational ROM can be added. Otherwise, it may be arranged such that plural types of PDL interpreters are previously stored in the program ROM 122a and the PDL interpreters can be selectively added by inputting a license key which becomes valid by a user's instruction using the console unit 104. Further, the ROM 122 includes a font data ROM (font ROM) 122b used upon interpretation of character codes in a print job and generation of image data, and a data ROM 122c including various image processing tables for binarization and the like.

Further, the CPU 121 can perform communication with the host computer 101 via a host interface unit 124. The CPU 121 receives print data from the host computer 101. Further, various status information of the printer 102 can be notified via the host I/F unit 124 to the host computer 101. Further, the printer 102 has a scanner 109, and image data read with the scanner 109 is processed by the controller 103, then a duplicate image is generated, and print-outputted or stored as a saved job in a box of an HDD 128. A timer 110 which performs timekeeping notifies the CPU 121 of time information or the like.

A RAM 123 provides a program area to which the control program executed by the CPU 121 is loaded, a work area for storage of various data and the like. The RAM 123 includes a reception buffer 123a for temporarily holding print data received from the host computer 101, a drawing object memory 123b holding the result of interpretation of print data in an intermediate object format, and the like. In addition, the RAM 123 includes a page spool memory 123c for mapping a page image based on the drawing object and holding the mapped page image, a work memory 123d for storage of environmental information and temporary data used in PDL drawing processing. Further, the RAM 123 includes a NVRAM (nonvolatile memory; not shown) for storing menu setting contents.

The HDD (hard disk) 128 has an area for registration of font data and overlay data inputted from the outside by download operation, and a box (folder) for holding print data received from the host computer 101. Hereinbelow, the print data accompanied by registration in the box will be noted as a box job or a saved job.

The console unit 104 has an operation panel for various menu settings and various operations such as resetting with respect to the printer 102, an LED, a display unit and the like for display of various statuses, an operator call and the like. A console I/F unit 127 controls interface between the console unit 104 and the controller 103. An ASIC 126 that is a custom LSI, realizes a part of functions of the printer 102. Note that in the printer 102, its memory capacity can be expanded using the optional RAM connected to an expansion port (not shown). The print unit 105 forms a latent image on a photosensitive drum in accordance with the video signal, heat-fixes the image to a print sheet thereby performs printing. As the print unit 105 according to the present embodiment, a print apparatus (image output apparatus) employing various printing methods for a laser-beam printer (hereinbelow “LBP”), an ink-jet printer or the like can be used. Further, the printer 102 may be a single-function type image output apparatus having only a print function, or may be a multi-function processing apparatus having plural functions such as copy/facsimile transmission/printing.

The host computer 101 is a host computer for a first user to output a saved job to the printer 102 for execution of reserved printing. In the following embodiment, the host computer 101 will be referred to as a first PC (first information processing apparatus). Further, the PCs 107 and 108 are personal computers used by at least one second user connected to the printer 102 and the first PC 101 with a prescribed network 106. In the present embodiment, the PCs 107 and 108 function as apparatuses to update print attribute information of a saved job by accessing update information (to be described later) stored in the printer 102 via the network 106.

Note that the update information is information for the first user to update the print attribute information of a saved job registered in the printer 102, and is generated in the HDD 128 upon registration of the saved job in the printer 102. At this time, the printer 102 notifies the first user of storage location information (URL) of the update information. On the other hand, the user of the second or subsequent PC (other than the first information processing apparatus), accesses the update information based on the URL received from the first user and updates the print attribute information of the saved job.

Note that the first PC 101 and the second and/or subsequent PCs 107 and 108 in the present embodiment have hardware and software configuration of a general personal computer.

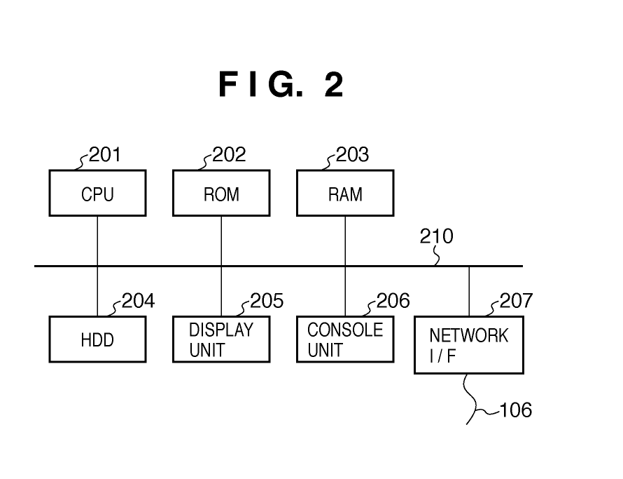

FIG. 2 is a block diagram showing a configuration of the PC (information processing apparatus) 101 according to the first embodiment.

A CPU 201 controls the entire operation of the PC. A ROM 202 holds a boot program. Upon startup of the PC, the CPU 201 reads an OS or the like installed in an HDD 204 and loads the read OS or the like to a RAM 203 in accordance with the boot program. A large capacity storage device (HDD) 204 such as a hard disk holds the OS, various applications and the like. A display unit 205, having a display such as a CRT or a liquid crystal display, is used for display of a UI screen or the like. A console unit 206, having a keyboard and a pointing device, is used for input of various data and commands in correspondence with the user's operation. A network interface 207 controls interface with the network 106. Numeral 210 denotes a bus connecting the above-described respective elements to the CPU 201.

Further, at least the first PC 101 is provided with a printer driver for generation of a saved job. The printer driver is program code to convert a print instruction from application software to PDL interpretable for the printer 102 and output the converted instruction. The printer driver is stored as a file in the HDD 204.

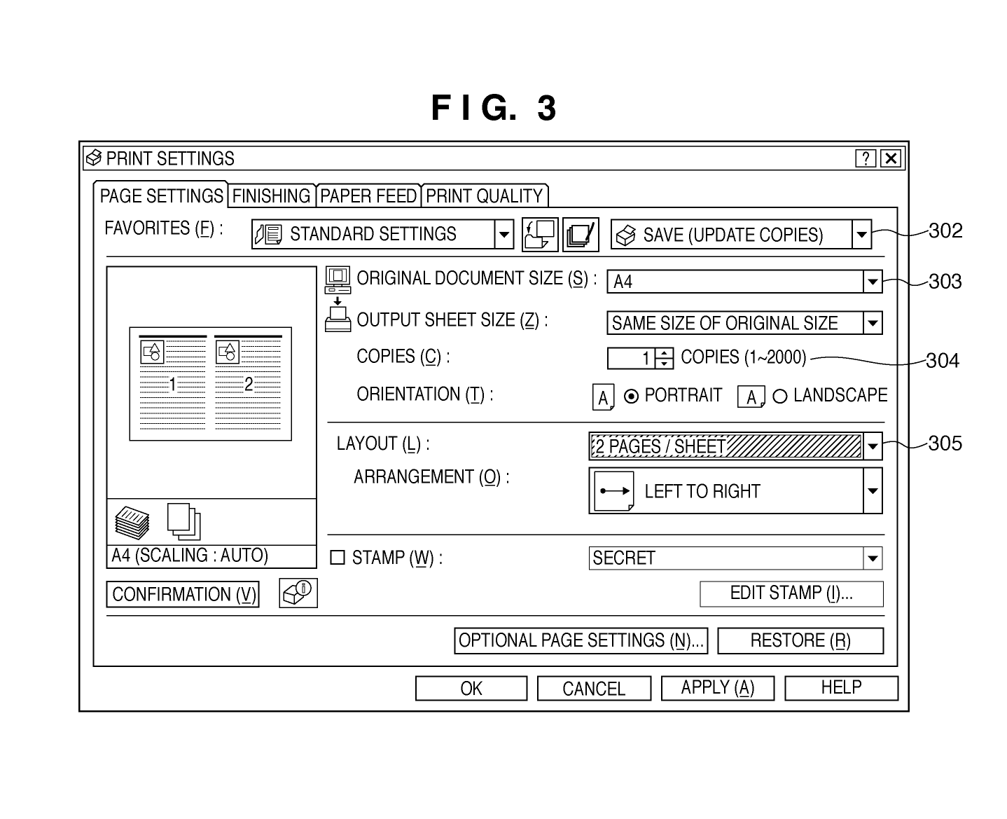

FIG. 3 depicts a view illustrating an example of a GUI screen of the printer driver according to the first embodiment.

FIG. 3 shows an example of a print tab for page setting having for example, an original document size selection box 303, a copies designator 304 for designation of the number of copies, a page layout setting section 305 for designation of layout such as “2 in 1”, and the like. In the present embodiment, as one of a print mode 302, a “save (update copies)” mode for designation of printing as a saved job allowing sharing and update of the number of copies by plural users can be designated. Note that when the “save (update copies)” mode is designated, as the number of copies is determined by access from the second and/or subsequent users, the number of copies upon start of the saved job may be an arbitrary number. Further, hereinbelow, the saved job with the designated “save (update copies)” mode is called an “update copies job” distinguishably from general saved jobs.

The contents of various print settings designated in this manner are held in the work area of the RAM 203 managed by the printer driver, and referred to upon conversion of a print instruction from the application into PDL data. Further, in the print quality tab in FIG. 3, settings related to print quality such as print resolution and a color mode can be made. In accordance with specifications set using the screen, image data is converted to PDL data and transmitted to the printer 102.

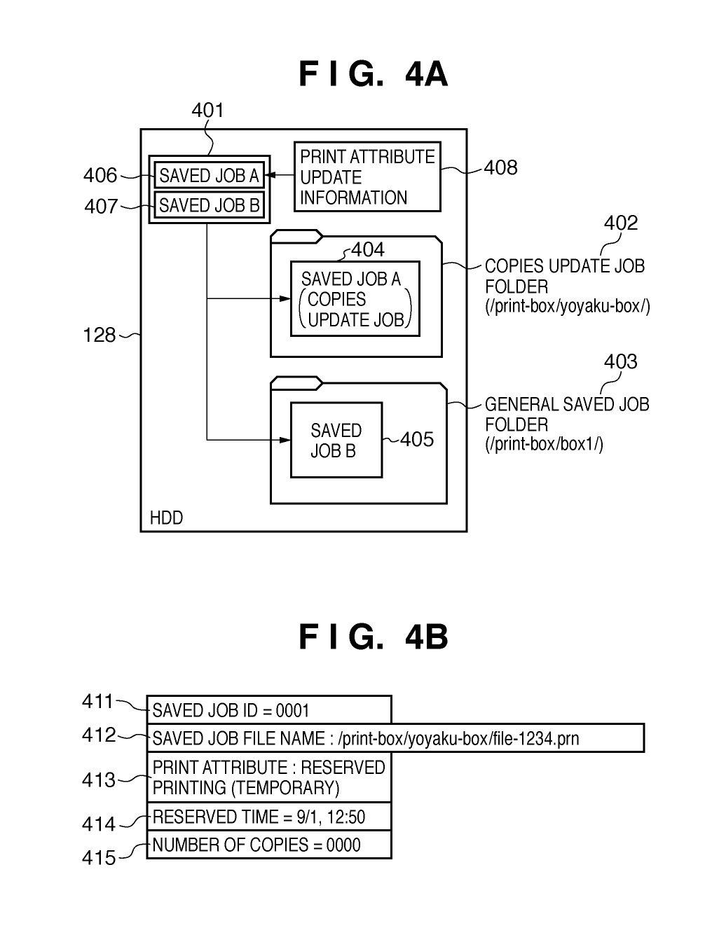

Next, referring to FIGS. 4A and 4B, the structure of saved job management information and the print attribute information of the saved job in the present embodiment will be described.

FIG. 4A shows a data structure in the HDD 128 of the printer 102 according to the first embodiment.

FIG. 4A shows a status where respective saved jobs are managed in a file directory structure. That is, a saved job A 404 is stored in a folder 402 discriminated with an absolute path name (/print-box/yoyaku-box/) from a root directory. Accordingly, when the file name of the saved job A 404 is “file-1234.prn”, it is specified with a path name “/print-box/yoyaku-box/file-1234.prn”.

Further, save job management data 401 includes the path names and print attribute data of the respective saved jobs. In this example, entries 406 and 407 corresponding to the respective saved job A 404 and saved job B 405 are registered. The saved job A 404, which is a copies update job in the designated “save (update copies)” mode, is stored in a specialized folder 402 for storage of copies update job. Further, print attribute update information 408, which is generated upon registration of copies update job, has a script accessible and executable by the second or subsequent PC with its URL. Further, as the saved job B 405 is a general saved job without designation of the “save (update copies)” mode, it is stored in a general saved job folder 403 (path name:/print-box/box1/) different from the folder for copies update job and controlled such that the print attribute can be arbitrarily changed.

FIG. 4B depicts a view illustrating an example of saved job management information for the saved job A.

A saved job ID 411 is identification information assigned by the printer 102 upon each registration of saved job as a unique ID to specify each saved job. A path name 412 is a path for access to a substantial file of the saved job A. In this example, the file name is “file-1234.prn”. The print attribute 413 indicates the print attribute of the saved job A. The print attribute 413 is designated from the UI screen of the printer driver shown in FIG. 3 upon registration of the saved job A. In the present embodiment, the print attribute 413 has any one of the following four types of values.

(1) Reserved printing: A print start instruction is issued and printing is performed at time designated from the UI screen of the printer driver. After the completion of the printing, the saved job is not deleted.
(2) Reserved printing (temporary): Also a print start instruction is issued and printing is performed at time designated from the UI screen of the printer driver. After the completion of the printing, the saved job is deleted.
(3) General saving: A print start instruction is issued and printing is performed in accordance with a print instruction from a user via a console panel or the like. After the completion of the printing, the saved job is not deleted.
(4) General saving (temporary): A print start instruction is issued and printing is performed in accordance with a print instruction from a user via the console panel or the like. After the completion of the printing, the saved job is deleted.

In the saved job A shown in FIG. 4B, (2) “reserved printing (temporary)” is designated as a print attribute. In this example, designation is made such that printing is started at “Sep. 1, 12:50” (twelve fifty on September 1) indicated as reserved time 414. Finally, number of copies 415 is managed by the control program such that immediately after registration of copies update job, the number of copies (=0) is set, and is incremented by 1 upon each access to the print attribute update information 408 from the user of the second or subsequent PC. Note that for a general saved job that is not a copies update job, the number of copies can be changed to an arbitrary number of copies using the console unit 104 of the printer 102.

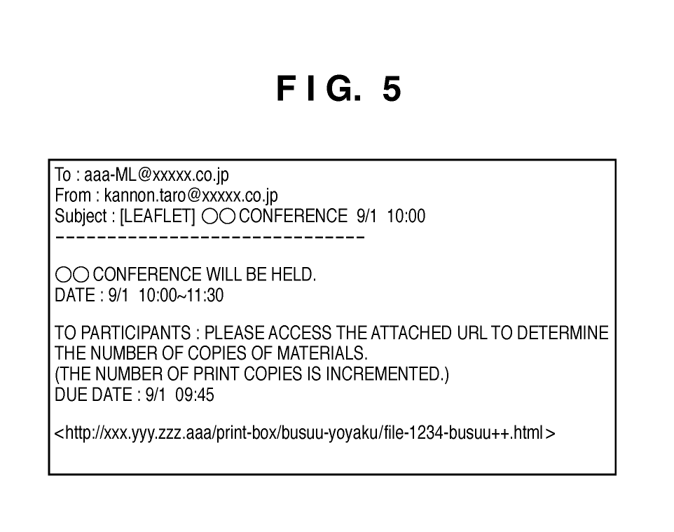

FIG. 5 depicts a view illustrating an example of an electronic mail of conference leaflet transmitted from the first PC to the second and/or subsequent PCs (users) in the present embodiment. The electronic mail includes a URL of print attribute update information of a copies update job.

The URL of the print attribute update information 408 of the copies update job “file-1234.prn” is represented as follows. Note that the IP address of the printer 102 is HTTP protocol accessible address “xxx.yyy.zzz.aaa”.

<http://xxx.yyy.zzz.aaa/print-box/busuu-yoyaku/file-1234-busuu++.html>

In the example of FIG. 5, in addition to the notification of conference, the above URL is attached, and in the second and/or subsequent PCs, the number of print copies of the saved job A is incremented upon each access to the URL by the user.

Note that in the present embodiment, the user inputs the message of the electronic mail with the first PC, however, it may be arranged such that the printer 102 generates the message of the electronic mail in addition to the URL, as a template.

Next, a number of copies update job registration procedure in an image output system according to the first embodiment will be described.

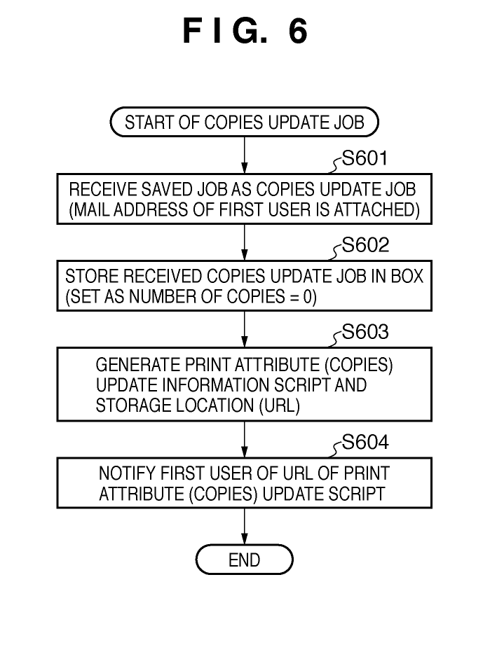

FIG. 6 is a flowchart describing the number of copies update job registration procedure. Note that the respective steps shown in the flowchart are realized by loading and executing the control program stored in the program ROM 122a by the CPU 121 of the printer 102.

First, in step S601, the printer 102 receives a saved job with indication of a copies update job from the PC 101. At this time, the printer driver of the PC 101 designates the mail address of the user of the first PC 101 previously inputted from the UI screen as one of the attributes of the generated copies update job, such that the URL of the print attribute update information 408 can be received from the printer 102. Next, in step S602, the copies update job received from the PC 101 is stored in the folder 402, then its saved job management information is generated. Note that the number of copies of the copies update job is previously set to “0”. Next, the process proceeds to step S603, in which the print attribute update information 408 and the storage location (URL) for the print attribute update information 408 are generated. Note that the print attribute update information 408 is HTLM format file data where a script for increment of the print attribute (the number of copies) of the saved job by one is described. Next, the process proceeds to step S604, in which the URL of the print attribute update information 408 is notified to the user of the first PC 101 by electronic mail, and the series of starting processing of the copies update job is completed.

Note that in the first embodiment, the mail address of the user of the first PC 101 is designated from the UI screen of the printer driver, however, the present invention is not limited to this arrangement. It may be arranged such that the mail address is determined from user information previously registered in the printer 102 and user information designated in the saved job.

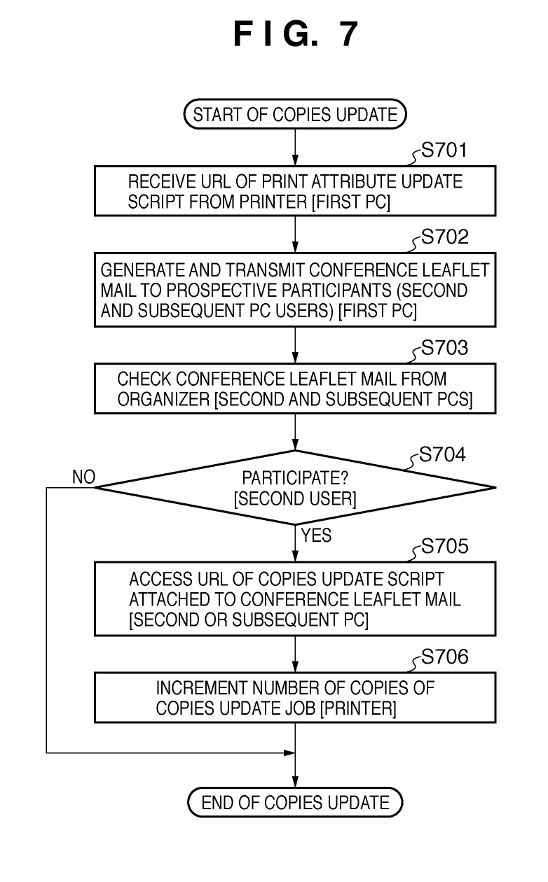

FIG. 7 is a flowchart describing a copies update procedure in the copies update job according to the first embodiment. Note that in the embodiment, a series of process flow includes processings by the first PC 101 in response to the operation by the first user as a conference organizer, in the second and/or subsequent PCs 107 to 108 in response to the operations by the second and/or subsequent users as participants, and in the printer 102. The processings in the first and second PCs are realized by execution of a program, installed in the HDD 204 and loaded to the RAM 203 upon execution, by the CPU 201. Further, the processing in the printer 102 is implemented by execution of a program stored in the program ROM 122a by the CPU 121.

First, in step S701, the first PC 101 registers the copies update job in the printer 102, then receives the URL of the print attribute update information 408 from the printer 102 by electronic mail. Next, in step S702, the conference leaflet is transmitted by electronic mail to the prospective participants of the conference (the second and/or subsequent users). At this time, the URL of the print attribute update information 408 is attached to the electronic mail, and the users to participate in the conference are requested to access the URL (see FIG. 5).

Then in step S703, the second and/or subsequent PC users receive the electronic mail from the first PC 101. Then in step S704, each user determines whether or not he/she is to participate in the conference, and when he/she is to participate in the conference, the process proceeds to step S705, in which the application operating on each PC in correspondence with user's operation accesses the URL. By the access to the URL, the printer 102 increments the number of copies 415 in the copies update job by one (+1) in step S706. On the other hand, if the second PC user determines not to participate in the conference at step S704, then the process ends without access to the URL of the print attribute update information 408.

By the above-described series of operations, the number of copies in the copies update job is incremented in the printer 102 by access to the URL by the second user. Further, when the other prospective participants (the third and subsequent users) who received the conference leaflet similarly perform the processing in steps S704 to S705, the number of copies corresponding to the final number of the participants to participate in the conference is set as the number of copies 415 as a print attribute of the copies update job.

Finally, at predetermined time described in the conference leaflet, by a print instruction from the user of the first PC 101, the printer 102 performs printing based on the copies update job in accordance with the updated number of copies. In this manner, the materials of the conference in just proportion to the number of participants of the conference can be print-outputted.

Note that in a case where reserved printing is designated as the print attribute 413 and the copies update job is print-outputted without user's operation at predetermined time, the processing flow including user's operation can be further reduced.

In the above-described first embodiment, one print attribute and print attribute update information correspond to one registered copies update job, and the number of prospective participants to participate in the conference is linked to the one value of number of copies. On the other hand, in the second embodiment, it may be arranged such that plural types of print attributes and print attribute update information correspond to one copies update job thereby the linkage is expanded.

For example, in the second embodiment, layout setting information to arrange print data for n pages on one print sheet and perform printing and the number of copies, linked to each other, are managed, thereby the number of print copies can be obtained in just proportion by layout in accordance with each of the second or subsequent user's preference. Note that in the embodiment, a layout to arrange print data for two pages on one print sheet is noted as “2in1”, and a layout to arrange print data for four pages on one print sheet, “4in1”. Further, when a saved job has been registered, the printer 102 can change the layout and perform printing.

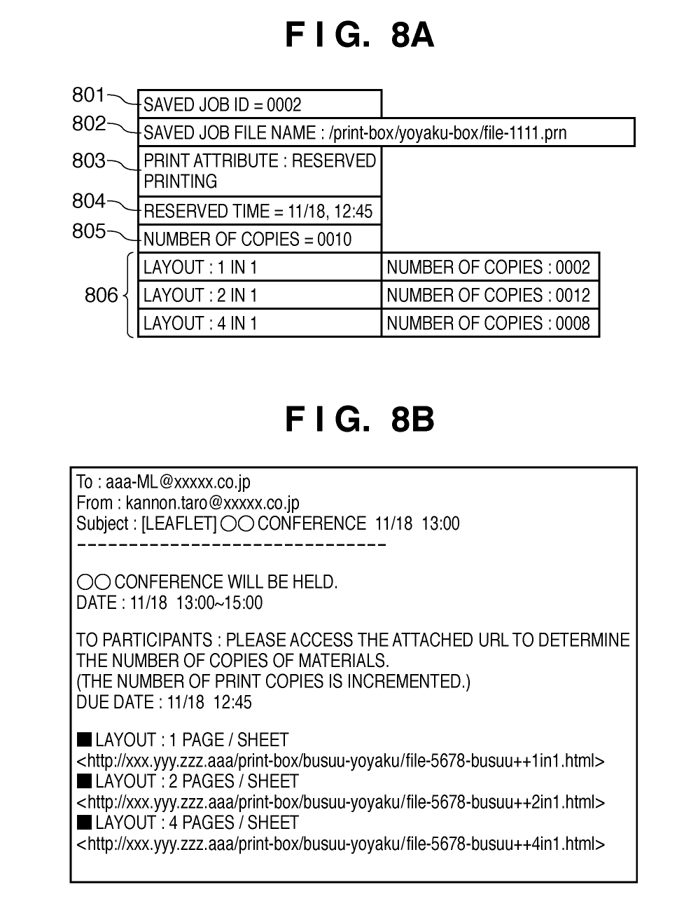

FIG. 8A depicts a view illustrating an example of saved job management information according to the second embodiment.

As numerals 801 to 805 correspond to the above-described saved job management information according to the first embodiment (411 to 415 in FIG. 4B), the explanations of the saved job management information 801 to 805 will be omitted. On the other hand, in layout information 806, the number of copies linked to the layout corresponds to each layout and the number of participants accessed to the information is stored. In the example of FIG. 8A, 1in1=2 copies, 2in1=12 copies and 4in1=8 copies hold. That is, total twenty-two participants have accessed the information.

Note that immediately after registration as a copies update job, the numbers of copies corresponding to all the layouts are set to “0”. Then each access from the second or subsequent PC user to the print attribute update information 408 corresponding to a desired layout setting, the number of copies is incremented by one, as in the case of the above-described first embodiment. Note that in FIG. 8A, the number of copies 805 “10” indicates that the number of print sheets required for printing the copies set in the layout setting is ten (i.e., “1in1” is 2 pages, “2in1” is 6 pages, and “4in1” is 2 pages).

FIG. 8B depicts a view illustrating an example of the electronic mail of conference leaflet transmitted from the first PC user to the second and/or subsequent PC users according to the second embodiment.

In the embodiment, the electronic mail includes URLs of plural print attribute update informations corresponding to plural layout setting informations (1in1, 2in1 and 4in1). When the user receives the electronic mail, he/she accesses a URL corresponding to a desired print layout.

Note that as in the case of the first embodiment, the printer 102 generates plural URLs, however, in the second embodiment, each print attribute update information is discriminated with a path name to specify each entry of the layout information 806.

As described above, according to the second embodiment, printing to obtain copies corresponding to the number of participants can be performed by each of different print layouts.

In the above-described first and second embodiments, the number of copies of the copies update job is uniquely determined in correspondence with the number of accesses to the print attribute update information by the second and/or subsequent PC users. However, it may be arranged such that the determination of the number of print copies has flexibility by setting a lower limit value of the number of print copies.

Next, a third embodiment will be described on the assumption that the number of prospective participants who determined to participate in the conference and the number of prospective participants who must participate in the conference are previously obtained. In this case, it may be arranged such that a least number of copies is added as saved job management information for the copies update job, and printing is performed using a greater one of the number of accesses from the second and/or subsequent PC users and the least number of copies as the number of print copies as the number of print copies. Note that the least number of copies may be designated from the UI screen of the printer driver in the first PC 101 upon registration of the copies update job by the first PC user, otherwise, the least number of copies may be designated by operating a print setting menu from the console unit 104 of the printer 102.

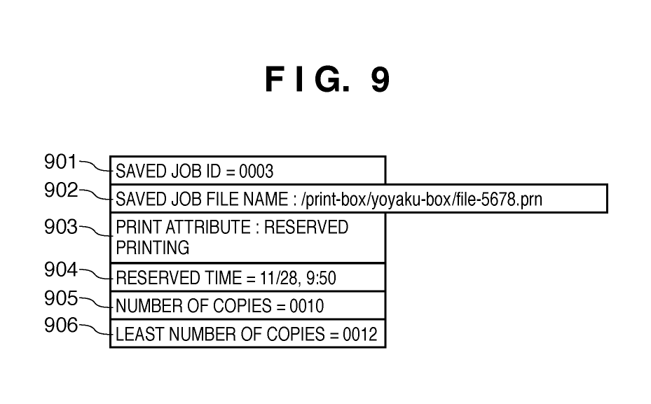

FIG. 9 depicts a view illustrating an example of the saved job management information according to the third embodiment.

In FIG. 9, as numerals 901 to 905 correspond to the above-described saved job management information 411 to 415 according to the first embodiment, the explanations of the saved job management information 901 to 905 will be omitted. A least number of copies 906 is previously set to “12” in FIG. 9. On the other hand, the number of copies is “10” by access to the print attribute update information 408 by the prospective participants. In this case, at reserved print time, the printer 102 performs printing to obtain “12 copies” as the least number of copies since the value of the number of copies 905 is less than the value of the least number of copies 906.

In this arrangement, the materials corresponding to the prescribed least number of participants can be infallibly prepared. Further, shortage of materials due to omission of access by the second or subsequent PC user can be prevented.

Further, it may be assumed that the user of the first PC 101 print-outputs a saved job in correspondence with the least number of copies in advance. That is, as an initial value of the number of copies of the saved job management information, a numerical value obtained by subtracting the number of previously printed copies from “0” may be set. For example, the first PC user first performs printing to obtain “8” copies corresponding to the least number of participants. Thereafter, the number of copies of the saved job management information is set to “−8”. Then, upon printing of the saved job, when the number of copies updated by user's access is a minus value, printing is not performed. In this arrangement, the same advantages as those obtained by the above-described print control to obtain the least number of copies can be attained.

Next, a fourth embodiment of the present invention will be described. In the fourth embodiment, an upper limit value of the number of print copies is set so as to provide a function of limiting a user's erroneous operation and unauthorized access by an ill-intentioned user.

The example of saved job management information according to the fourth embodiment is basically the same as the saved job management information according to the above-described third embodiment shown in FIG. 9. In the fourth embodiment, the least number of copies is handled as a maximum number of copies. That is, upon printing of copies update job, smaller one of the numerical values of the number of copies of updated number of copies 905 and the maximum number of copies is used as the number of copies in actual printing.

Further, when the second and/or subsequent PC users access the URL of the print attribute update information 408 thereby update the number of copies and the number of copies exceeds the maximum number of copies, a message indicating that the number of copies has become the maximum number of copies may be notified to the user. Otherwise, it may be arranged such that the mail address of the user of the first PC 101 is held in the saved job management information in FIG. 4A, then the printer 102 refers to the mail address and notifies the user of the first PC 101 of the fact that the number of copies has become the maximum number of copies.

As described above, according to the fourth embodiment, the occurrence of wasteful printing due to a user's operation error or unauthorized access can be suppressed.

In the above-described first embodiment, the print attribute “reserved printing (temporary)” is designated for a copies update job. Accordingly, printing is performed in accordance with the number of copies 415 at reserved time, then the copies update job (saved job A) is deleted from the folder 402. Accordingly, it is not necessary for the user to care about the problem such as shortage of memory capacity due to accumulation of saved jobs.

On the other hand, in the fifth embodiment, “(1) reserved printing” is designated in the print attribute, and after the completion of reserved printing, the saved job is not deleted. In this case, when the user of the second or subsequent PC accesses the URL of the print attribute update information 408 after the designated time in the reserved printing, the increment of the number of copies is not performed, but one copy of the copies update job is immediately print-outputted.

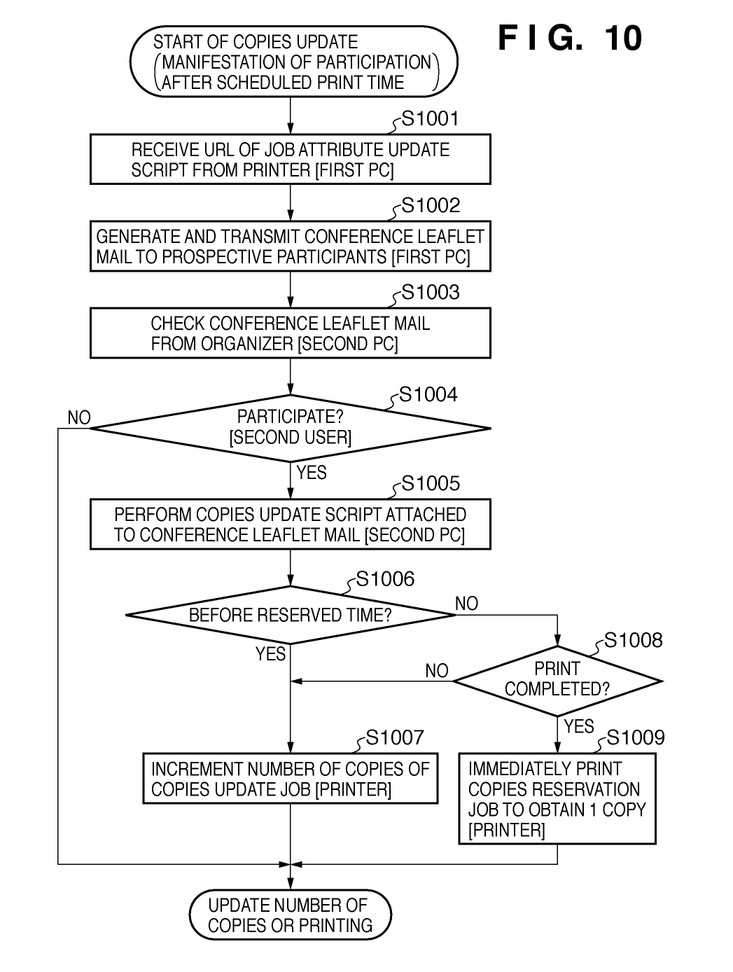

FIG. 10 is a flowchart describing the copies update procedure for the copies update job according to the fifth embodiment. Note that in the embodiment, a series of process flow includes processings by the first PC 101 in response to the operation by the first user as a conference organizer, in the second and/or subsequent PCs 107 to 108 in response to the operation by the second and/or subsequent users as participants, and in the printer 102. The processings in the first and second PCs are realized by execution of a program, installed in the HDD 204 and loaded to the RAM 203 upon execution, by the CPU 201. Further, the processing in the printer 102 is implemented by execution of a program stored in the program ROM 122a by the CPU 121. Note that in FIG. 10, as the respective steps S1001 to S1004 correspond to the above-described steps S701 to S704 in FIG. 7 according to the first embodiment, the explanations of the steps will be omitted.

When there is access indicating participation from the user, the process proceeds from step S1004 to step S1005, in which the printer 102 performs copies update by access from the second or subsequent PC to the URL of the print attribute update information 408. In the fifth embodiment, in step S1006, the printer 102 obtains current time from the timer 110, compares the obtained time with reserved time 414 designated upon registration of reserved printing. If it is determined in step S1006 that the current time is before the reserved time 414, the process proceeds to step S1007, in which the number of copies of the copies update job is incremented by one (+1) as in the case of step S706 in the first embodiment. With the series of operations by this step, the manifestation of participation by one person is reflected in the number of copies. Further, when the other prospective participants (the third and subsequent PC users) perform processing in steps S1003 to S1007, the number of copies reflecting the number of participants to participate in the conference is set in the print attribute.

On the other hand, in step S1006, if the second or subsequent PC user accesses the URL at the same time of the reserved time 414 or later than the reserved time, the process proceeds to step S1008, in which the printer 102 examines whether or not printing based on the copies update job has been completed. If it is determined that the printing has not been completed, then the process proceeds to step S1007, in which the number of copies is incremented. Accordingly, it is determined that the user's access to the print attribute update information 408 (i.e., the manifestation of participation) is made before the reserved printing.

On the other hand, if it is determined in step S1008 that the printing has been completed, then the process proceeds to step S1009, in which the printer 102 immediately print-outputs the copies update job with the setting of number of copies=1.

As described above, according to the fifth embodiment, when the participant of the conference accesses the print attribute update information after the completion of printing of the copies update job, the copies update job is immediately print-outputted instead of updating the number of copies of the saved job management information, thereby the increment of number of copies due to the increment of the participants immediately before the conference can be handled.

In the sixth embodiment, when the second or subsequent PC user accesses the URL of the print attribute update information 408, user identification information is transmitted to the printer 102. Note that as long as the user identification information is information uniquely assigned to each user such as each user's mail address or network account, the user identification information is not particularly limited.

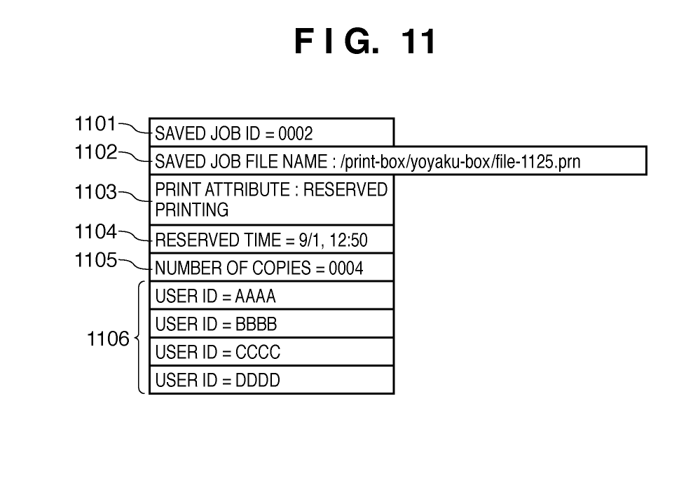

FIG. 11 depicts a view illustrating an example of the saved job management information according to the sixth embodiment. In FIG. 11, as print attributes 1101 to 1105 correspond to the above-described saved job management information 411 to 415 according to the first embodiment shown in FIG. 4B, the explanations of the saved job management information 1101 to 1105 will be omitted.

The user identification information 1106, which is a print attribute characteristic of the sixth embodiment, holds identification information of a user who accessed the URL of the print attribute update information 408. Note that the number of the user identification informations 1106 is the same as the number of copies 1105, and is “0” immediately after registration of the copies update job. Every time the second or subsequent PC user accesses the URL to increment the number of copies 1105, a storage area for the user identification information is allocated.

In the above arrangement, upon access to the URL from the second or subsequent PC user, it is determined whether or not the same user identification information 1106 has already been stored. When the same user identification information is found, control is performed not to update the number of copies 1105. By this processing, management not to allow update of the number of copies by plural times of access to the URL by the same user can be realized.

In further embodiment, upon access from the second or subsequent PC user to the URL of the print attribute update information 408, the user identification information is transmitted to the printer 102, thereby identification information of the user who updated the number of copies can be printed on each cover sheet of for example, the copies update job. In this embodiment, the control program for the printer 102 generates PDL data to print the user identification information, and performs processing in correspondence with time of the PDL interpretation in the copies update job. Further, a list of participants can be generated and printed based on the user identification information by a similar method.

Note that the above-described respective embodiments, the number of copies is incremented by 1 by each user's access to the URL. However, the present invention is not limited to this arrangement. The increment of the number of copies may be designated with an arbitrary number. In this arrangement, for example, manifestation of participation of plural users can be made by a representative of a section.

### Other Embodiment

Further, aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-063239, filed Mar. 16, 2009 which is hereby incorporated by reference herein in its entirety.

What is claimed is:

1. A print apparatus, comprising:
a storage unit that stores received print data with a print attribute;
a notification unit that notifies an information processing apparatus of update information to update the print attribute;
an update unit that updates the print attribute in accordance with an access from the information processing apparatus to the update information; and
a print control unit that performs printing based on the print data in accordance with the updated print attribute in correspondence with a print start instruction for the print data.

2. The print apparatus according to claim 1, wherein the print attribute includes a number of print copies,
and wherein the update unit updates the number of print copies in accordance with access to the update information from the information processing apparatus.

3. The print apparatus according to claim 1, wherein the print attribute includes a print layout and the number of print copies corresponding to the print layout,
wherein the update information is information to update the number of print copies corresponding to each print layout, and
wherein the update unit updates the number of print copies in the print layout corresponding to access from the information processing apparatus to the update information.

4. The print apparatus according to claim 1, further comprising a setting unit that sets at least one of the upper limit value and the lower limit value of the number of print copies,
wherein if the number of print copies updated by the update unit is greater than the upper limit value, then the print control unit sets the number of print copies to the upper limit value, while if the number of print copies updated by the update unit is smaller than the lower limit value, then the print control unit sets the number of print copies to the lower limit value, then performs printing based on the print data.

5. A print system in which a print apparatus and a plurality of information processing apparatuses are interconnected via a network,
wherein the print apparatus comprising:
a storage unit that receives a print job from a first information processing apparatus and stores the received print job with a print attribute;
a notification unit that notifies the first information processing apparatus of update information to update the print attribute;
an update unit that updates the print attribute in accordance with an access to the update information from the information processing apparatus; and
a print control unit that performs printing based on the print data in accordance with the updated print attribute, in response to a print start instruction for the print data,
wherein the first information processing apparatus having a transmission unit that transmits the update information to other information processing apparatus than the first information processing apparatus,
and wherein the other information processing apparatus than the first information processing apparatus having a unit that accesses the update information transmitted by the transmission unit.

6. The print system according to claim 5, wherein the print attribute includes a number of print copies,
and wherein the update unit updates the number of print copies in accordance with an access from the information processing apparatus to the update information.

7. The print system according to claim 5, wherein the print attribute includes a print layout and a number of print copies corresponding to each print layout,
wherein the update information is information to update the number of print copies corresponding to each print layout,
and wherein the update unit updates the number of print copies in the print layout corresponding to the access from the information processing apparatus to the update information.

8. The print system according to claim 5, the print apparatus further comprising a setting unit that sets at least one of upper limit value and a lower limit value of the number of print copies,
wherein if the number of print copies updated by the update unit is greater than the upper limit value, then the print control unit sets the number of print copies to the upper limit value, while if the number of print copies updated by the update unit is smaller than the lower limit value, then the print control unit sets the number of print copies to the lower limit value and performs printing based on the print data.

9. A method of controlling a print apparatus, comprising:
a storage step of storing received print data, with a print attribute, in a memory;
a notification step of notifying an information processing apparatus of update information to update the print attribute;
an update step of updating the print attribute in accordance with an access from the information processing apparatus to the update information; and
a print control step of performing printing based on the print data in accordance with the updated print attribute in correspondence with a print start instruction for the print data.
